(19) United States
(12) Patent Application Publication
(10) Pub. No.: US 2015/0105998 A1
(43) Pub. Date: Apr. 16, 2015

(54) CONTROLLING METHOD FOR FLAME JET IGNITION ENGINE

(71) Applicant: Hyundai Motor Company, Seoul (KR)

(72) Inventors: Won Jun LEE, Incheon (KR); Byong Young CHOI, Bucheon-si (KR); Soo Hyung WOO, Yongin-si (KR); Jin Kook KONG, Suwon-si (KR)

(73) Assignee: Hyundai Motor Company, Seoul (KR)

(21) Appl. No.: 14/133,399

(22) Filed: Dec. 18, 2013

(30) Foreign Application Priority Data
Oct. 16, 2013 (KR) 10-2013-0123663

(51) Int. Cl. F02D 41/00

(52) U.S. Cl. CPC F02D 41/0057
USPC 701/104

(57) ABSTRACT

A controlling method for a flame jet ignition engine includes: a setting step of setting a map as a low load operation region, a medium load operation region, and a high load operation region depending on a load which is measured at the time of the driving of the engine; and a first burning step of performing burning by being controlled with an air-fuel ratio more lean than a theoretical air-fuel ratio and reducing NOx while increasing and compensating for a burning rate depending on burning of the jet ignition apparatus, at the time of entering the low load operation region and the medium load operation region.

### CROSS REFERENCE TO RELATED APPLICATION

The present application claims priority of Korean Patent Application Number 10-2013-0123663 filed Oct. 16, 2013, the entire contents of which application is incorporated herein for all purposes by this reference.

### BACKGROUND OF INVENTION

1. Field of Invention

The present invention relates to a controlling method for an engine, and more particularly, to a controlling method for a flame jet ignition engine satisfying a NOx regulation value without a separate post-processing apparatus by reduction in temperature depending on lean burning and by rapid burning.

2. Description of Related Art

Generally, an engine for driving a vehicle obtains power by burning fuel, such as gasoline and diesel and therefore emits a large amount of exhaust gas at the time of burning of fuel.

The exhaust gas includes a large amount of CO, HC, NOx, and the like which are harmful to a human body. Therefore, when the exhaust gas is emitted to the air as it is, serious environmental pollution may occur and respiratory ailments may occur.

To solve the problems, various post-processing apparatuses using a catalyst are mounted on an exhaust pipe which emits the exhaust gas, in order to oxidize harmful CO, HC, and NOx in the exhaust gas into CO₂, H₂O, and N₂, to purify, and then to emit to the air.

As the representative post-processing apparatus purifying the exhaust gas, a three-way catalyst is mainly used. For purification action using the three-way catalyst, when the engine is controlled by an air fuel ratio which is based on a so-called theoretical air-fuel ratio, a catalyst reaction is activated and thus purification efficiency is improved.

However, in order to improve the recent fuel consumption efficiency, a lean-bum system which bums the exhaust gas with a lean air-fuel ratio is mainly used. In the region in which the air-fuel ratio is lean, a reduction rate of CO and HC may be increased, but a reduction rate of NOx may be suddenly reduced. On the contrary, when the air-fuel ratio is controlled thickly, the reduction rate of NOx may be increased, but the reduction rate of CO and HC may be reduced.

In particular, in the case of the lean-bum engine which is considerably out of the theoretical air-fuel ratio, the purification efficiency holding ability may be limited and the purification ability of NOx may be remarkably reduced due to the increase in oxygen amount in the exhaust gas. To solve the problem, a separate post-processing apparatus needs to be mounted on the exhaust pipe.

Meanwhile, as the related art, Korean Patent Laid-Open Publication No. 1996-0011090 entitled “Lean-bum Engine For Vehicle” is disclosed.

Loom However, even in the method according to the related art, a separate exhaust system for removing NOx needs to be additionally provided, and thus cost and weight may be increased.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a controlling method for a flame jet ignition engine satisfying a NOx regulation value without a separate post-processing apparatus by reduction in temperature depending on lean burning and by rapid burning.

Various aspects of the present invention provide for a controlling method for a flame jet ignition engine, including: a setting step of setting a map as a low load operation region, a medium load operation region, and a high load operation region depending on a load which is measured at the time of the driving of the engine; and a first burning step of performing burning by being controlled with an air-fuel ratio more lean than a theoretical air-fuel ratio and reducing NOx while increasing and compensating for a burning rate depending on burning of the jet ignition apparatus, at the time of entering the low load operation region and the medium load operation region.

In the medium load operation region, low temperature burning may be performed by using EGR gas.

In the first burning step, the air-fuel ratio of the low load operation region may control an excess air ration to λ>1.8.

In the first burning step, an air-fuel ratio of the medium load operation region may control an excess air ration to 2.4>λ>1.8.

The controlling method for a flame jet ignition engine may further include: a second burning step of performing the control and the burning within an excess air ratio width (λ-window), which holds conversion efficiency of a three way catalyst, based on the theoretical air-fuel ratio and reducing NOx using the three way catalyst, at the time of entering the high load operation region.

In the high load operation region, low temperature burning may be performed by using EGR gas.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a flow of an exemplary controlling method for an engine according to the present invention; and

FIG. 2 is a diagram conceptually illustrating a state of each of the load regions which is divided into a high load operation region, a medium load operation region and a low load operation region for an exemplary controlling method for an engine according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

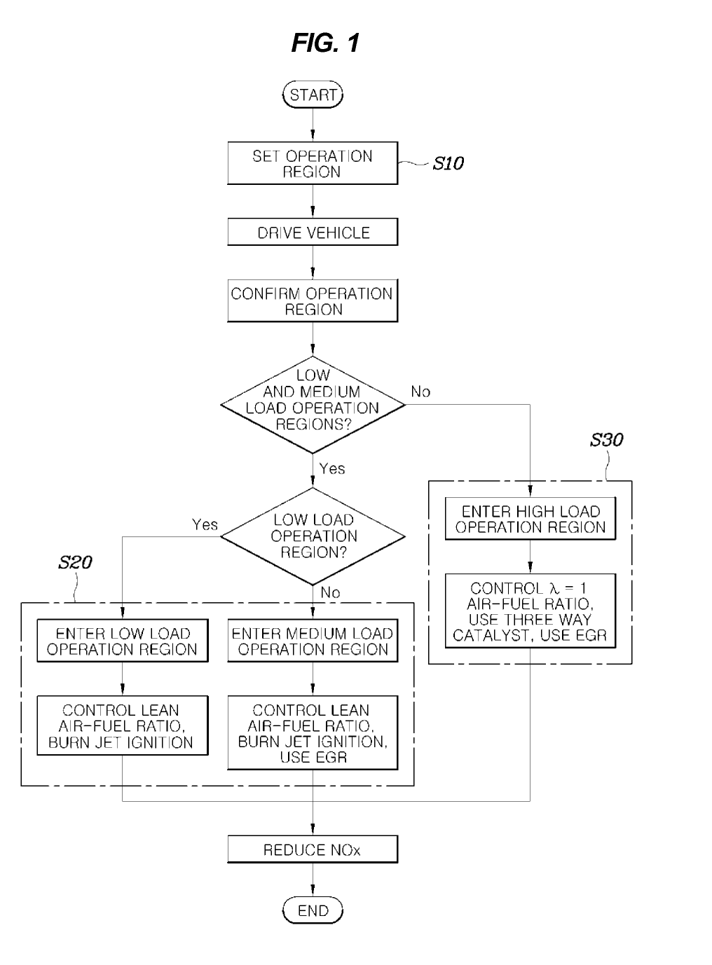

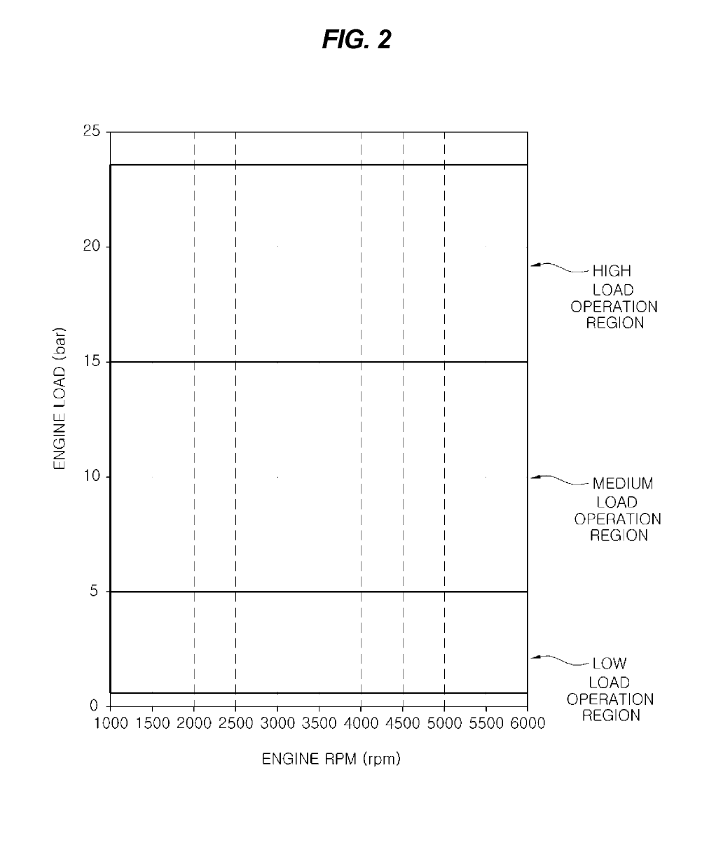

FIG. 1 is a diagram illustrating a flow of a controlling method for an engine according to various embodiments of the present invention, in which the controlling method is performed by a vehicle engine controller, for example, a central processing unit (CPU) or other suitable means. FIG. 2 is a diagram conceptually illustrating a state of each of the load regions which is divided for the controlling method for an engine according to various embodiments of the present invention.

The controlling method for a flame jet ignition engine according to various embodiments of the present invention is configured to largely include a setting step (S10) and first burning step (S20).

Describing various embodiments of the present invention with reference to FIGS. 1 and 2, the controlling method for a flame jet ignition engine may be configured to include the setting step (S10) of setting a map as a low load operation region, a medium load operation region, and a high load operation region depending on a load which is measured at the time of the driving of the engine and a first burning step (S20) of performing burning by being controlled with an air-fuel ratio more lean than a theoretical air-fuel ratio and reducing NOx while increasing and compensating for a burning rate depending on reserved burning of the jet ignition apparatus, at the time of entering the low load operation region and the medium load operation region.

That is, when a vehicle drives by entering the pre-established low load operation region and medium load operation region, the burning is made by being controlled with the lean air-fuel ratio and thus the burning temperature is reduced. However, since a burning rate depending on the burning of the lean air-fuel ratio is reduced larger than a burning rate depending on the theoretical air-fuel ratio, the burning rate needs to be increased by the jet ignition apparatus to compensate for the burning rate. Therefore, in the low load operation region and the medium load operation region, the burning rate is improved while reducing the burning temperature, due to the lean burning, such that the reduction rate of NOx may be increased 98% or more while reducing a fuel consumption rate, thereby satisfying a regulation value of EURO6 without a separate post-processing apparatus.

Herein, an engine load which divides the low load, medium load, and high load operation regions may be a load which is calculated using a brake mean effective pressure.

Further, the jet ignition apparatus is an apparatus which does not use an existing ignition plug as an ignition source of a main combustion chamber, but burns a small amount of fuel in an auxiliary combustion chamber and uses as the ignition source a frame having a jet shape generated at the time of burning.

As such, by using the jet frame using the jet ignition, the burning starts at a line having a jet shape and therefore the burning rate within the combustion chamber may be considerably increased.

As the jet ignition apparatus used in various embodiments of the present invention, Korean Patent Laid-Open Publication No. 10-2013-0055154 entitled “Jet Ignition Apparatus for Engine” may be used. Further, any one of various types of jet ignition apparatuses used to improve a burning rate may be used.

Meanwhile, in the medium load operation region according to various embodiments of the present invention, low temperature burning may be performed by using EGR gas.

That is, in the low load operation region, the reduction amount in NOx is increased 98% or more by the lean burning and the ignition burning using the jet ignition apparatus. In this case, since the medium load operation region has burning temperature slightly higher than the low load operation region, the low temperature burning is implemented using the EGR gas in the burning. In this case, the EGR gas may be used when burning stability is secured.

In the first burning step (S20) according to various embodiments of the present invention, the air-fuel ratio of the low load operation region may be controlled for an excess air ratio to be λ>1.8.

Further, in the first burning step (S20) according to various embodiments of the present invention, the air-fuel ratio of the medium load operation region may be controlled for an excess air ratio to be 2.4>λ>1.8.

That is, at the time of entering the low load operation region, the low temperature burning is performed by a lean-burn control in which the excess air ratio exceeds 1.8, such that the reduction ratio of NOx may be improved without the separate post-processing apparatus.

Further, in various embodiments, at the time of entering the medium load operation region, the low temperature burning is performed by the lean burn control in which the excess air ratio preferably exceeds 1.8 and is less than 2.4 and the low temperature burning is performed using the EGR gas, such that even in the medium load operation region, the reduction rate of NOx may be improved without the separate post-processing apparatus.

The controlling method for a flame jet ignition engine according to various embodiments of the present invention may include a second burning step (S30) of performing the control and the burning within an excess air ratio width (λ-window), which holds conversion efficiency of a three way catalyst, based on the theoretical air-fuel ratio and reducing the NOx using the three way catalyst, at the time of entering the high load operation region.

That is, the three way catalyst has the reduction performance of CO, HC, and NOx which are contradictory with each other in a region of λ>1 and λ<1 and the air-fuel ratio supplied to the engine needs to be supplied as the theoretical air-fuel ratio to simultaneously reduce the three components.

Actually, since the excess air ratio width (λ-window) holding the conversion efficiency of the three way catalyst based on the theoretical air-fuel ratio is present, the purification efficiency of the three way catalyst greatly shows up within a range of the excess air ratio width.

Therefore, in various embodiments, in the high load operation region, the control and the burning are preferably performed as the air-fuel ratio approximating λ=1, and thus the conversion efficiency of the three way catalyst is held, such that the reduction ratio of NOx may be increased by using the three way catalyst, thereby satisfying the NOx regulation value.

Herein, in the high load operation region, the low temperature burning may be performed by using the EGR gas.

That is, the internal EGR using a valve timing and the external EGR are used as large as possible and thus the generation of NOx may be reduced.

According to various embodiments of the present invention, the fuel consumption rate may be reduced and the reduction rate of NOx may be increased 98% or more by reducing the burning temperature with the lean-burn control and improving the burning rate using the jet ignition apparatus in the low load operation region and the medium load operation region, thereby satisfying the regulation value of EURO6 without the separate post-processing apparatus.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. A controlling method for a flame jet ignition engine, comprising:
a setting step performed by a controller, the setting step setting a map as a low load operation region, a medium load operation region, and a high load operation region depending on a load which is measured at the time of the driving of the engine; and
a first burning step of performing burning by being controlled with an air-fuel ratio more lean than a theoretical air-fuel ratio and reducing NOx while increasing and compensating for a burning rate depending on burning of the jet ignition apparatus, at the time of entering the low load operation region and the medium load operation region.

2. The controlling method of claim 1, wherein in the medium load operation region, low temperature burning is performed by using EGR gas.

3. The controlling method of claim 1, wherein in the first burning step, the air-fuel ratio of the low load operation region controls an excess air ration to λ>1.8.

4. The controlling method of claim 1, wherein in the first burning step, an air-fuel ratio of the medium load operation region controls an excess air ration to 2.4>λ>1.8.

5. The controlling method of claim 1, further comprising:
a second burning step of performing the control and the burning within an excess air ratio width (λ-window), which holds conversion efficiency of a three way catalyst, based on the theoretical air-fuel ratio and reducing NOx using the three way catalyst, at the time of entering the high load operation region.

6. The controlling method of claim 5, wherein in the high load operation region, low temperature burning is performed by using EGR gas.
